(19) United States
(12) Patent Application Publication
(10) Pub. No.: US 2006/0086001 A1
(43) Pub. Date: Apr. 27, 2006

(54) Washing machine combined with dryer

(75) Inventors: In Chul Jeong, Seoul (KR); Young Hwan Park, Seoul (KR); Sog Kie Hong, Seoul (KR); Dae Yun Park, Gwangmyung-si (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/185,767

(22) Filed: Jul. 13, 2005

(30) Foreign Application Priority Data
Oct. 22, 2004 (KR) 84925/2004
Oct. 22, 2004 (KR) 84926/2004

(51) Int. Cl. F26B 11/02

(52) U.S. Cl. 34/606; 34/607

(57) ABSTRACT

A washing machine combined with a dryer is provided. In the washing machine combined with the dryer, a tub is provided, a dryer duct is installed outside of the tub, a dryer fan is installed in the dryer duct to draw in a surrounding air, a heater is installed in the dryer duct to apply heat to the drawn-in air, and a screening unit is installed in the dryer duct to selectively block the flow of the air, wherein the dryer duct includes an air inlet to introduce the surrounding air, an air outlet connected to the tub to allow the introduced air to flow into the tub, and an air passage formed between the air inlet and the air outlet to pass the introduced air therethrough.

### BACKGROUND OF THE INVENTION

1. Field of the Invention

The present invention relates to a washing machine, and more particularly, to a washing machine combined with a dryer, which has a screening unit to prevent a hot steam, generated in a drum during a hot water washing operation, from reversely flowing along a dryer duct toward the outside of a tub or the outside of the washing machine.

2. Description of the Related Art

A washing machine is a home appliance for washing clothes automatically. In a typical washing machine, a motor spins a drum to agitate clothes together with water containing detergent to remove dirt from the clothes.

A drum type washing machine is becoming very common. In the drum type washing machine, clothes are lifted and dropped to force water and detergent solution to pass through the clothes to remove dirt from the clothes. Since the clothes are lifted and dropped in the drum, the drum type washing machine can clearly washes the clothes while damaging the clothes less than other types of washing machines. Also, the drum type washing machine can wash more clothes at a time than other types of washing machines.

Further, a washing machine combined with a dryer is introduced to eliminate the inconvenience of using a washing machine and a dryer separately. Washing machines combined with a dryer can be classified into a condenser type and a vented type depending on a drying method.

The washing machine combined with the condenser type dryer removes residual moisture from clothes by circulating a heated air through a drum. On the contrary, the washing machine combined with the vented type dryer removes residual moisture from clothes by blowing a heated air into a drum and discharging the air to the outside through a tub and an air-vent duct. Here, the air discharged has a relatively high humidity because it has taken moisture from the clothes in the drum.

The washing machine combined with the vented type dryer is provided at an upper portion with a dryer duct in which a flower fan and a heater are installed. The blower fan draws in air from between a cabinet and a tub, and the heater applies heat to the air. An outlet of the dryer duct is connected to a drum to direct the heated air into the drum. The air takes moisture from clothes in the drum and then the air is discharged to the outside.

However, the washing machine combined with the vented dryer has a disadvantage in that a hot steam, generated during a hot water washing operation, flows reversely into the dryer duct and leaks to the outside.

That is, through an inlet of the dryer duct where the blower fan is installed, the steam reversely flows toward a space between the tub and the cabinet and discharged to the outside of the washing machine through a gap defined at a connecting portion of the cabinet, thereby increasing humidity of the room and causing problems such as mildew on the walls.

Further, the steam makes the cabinet rusted. Furthermore, when the steam infiltrates, into electric components and condenses therein, it causes malfunction of electrical components and increases the possibility of a fire.

### SUMMARY OF THE INVENTION

Accordingly, the present invention is directed to a washing machine combined with a dryer that substantially obviates one or more problems due to limitations and disadvantages of the related art.

An object of the present invention is to provide a washing machine combined with a dryer, in which a hot steam generated during a hot water washing operation is prevented from reversely flowing to the outside of the washing machine through a dryer duct.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a washing machine combined with a dryer includes: a tub; a dryer duct installed outside of the tub, the dryer duct including an air inlet to introduce a surrounding air, an air outlet connected to the tub to allow the introduced air to flow into the tub, and an air passage formed between the air inlet and the air outlet to pass the introduced air therethrough; a dryer fan installed in the dryer duct to draw in the surrounding air; a heater installed in the dryer duct to apply heat to the drawn-in air; and a screening unit installed in the dryer duct to selectively block the flow of the air.

In another aspect of the present invention, a washing machine combined with a dryer includes: a cabinet; a tub accommodated in the cabinet; a dryer duct allowing a surrounding air to flow inside of the tub from between the cabinet and the tub; a dryer fan installed in the dryer duct to draw in the surrounding air; a heater installed in the dryer duct to apply heat to the drawn-in air; and a screening unit including a screen rotatably installed in the dryer fan and a hinge protruded from a side of the screen.

In a further another aspect of the present invention, a washing machine combined with a dryer includes: a dryer duct; a dryer fan installed in the dryer duct to draw in a surrounding air; a heater installed in the dryer duct to apply heat to the drawn-in air; and a screening unit including a screen rotatably installed in the dryer fan and a hinge protruded from a side of the screen.

According to the present invention, the hot steam generated during the hot water washing operation is prevented from reversely flowing to the outside of the washing machine through the dryer duct.

Therefore, problems resulting from high humidity in room, such as mildew on walls, can be prevented.

Further, the cabinet or the tub of the washing machine can be prevented from rusting.

Furthermore, the electrical components of the washing machine can be prevented from firing and malfunctioning.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a washing machine combined with a vented dryer that is provided with a screening unit to prevent an adverse flow of steam according to the present invention;

FIG. 2 is a side sectional view of the washing machine combined with the vented dryer depicted in FIG. 1;

FIG. 3 is a perspective view of a screening unit according to an embodiment of the present invention;

FIG. 4 shows an inside of a dryer duct during a heat drying operation according to an embodiment of the present invention;

FIG. 5 shows an inside of a dryer duct when a heat drying operation is not carried out according to an embodiment of the present invention;

FIG. 6 is a perspective view of a screening unit according to another embodiment of the present invention;

FIG. 7 shows an inside of a dryer duct during a heat drying operation according to another embodiment of the present invention; and

FIG. 8 shows an inside of a dryer duct when a heat drying operation is not carried out according to another embodiment of the present invention.

### DETAILED DESCRIPTION OF THE INVENTION

Reference will now be made in detail to the preferred embodiments of the present invention, examples of which are illustrated in the accompanying drawings.

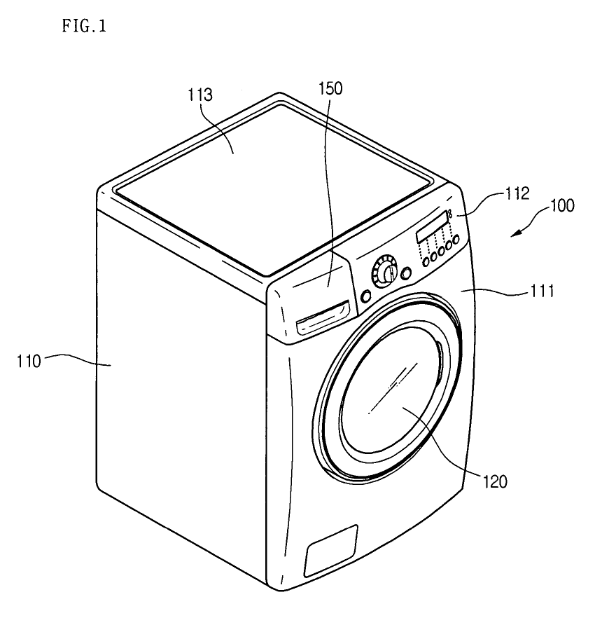

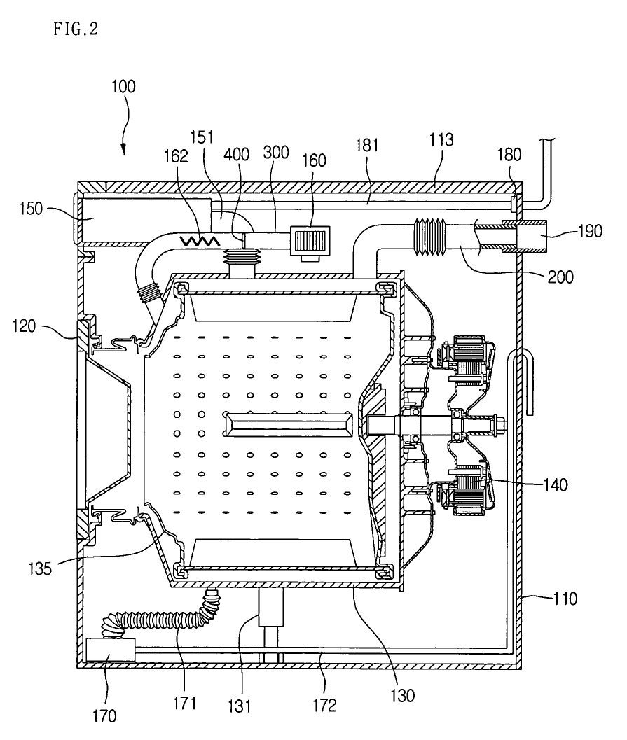

FIG. 1 is a perspective view of a washing machine combined with a vented dryer that is provided with a screening unit to prevent an adverse flow of steam according to the present invention, and FIG. 2 is a side sectional view of the washing machine combined with the vented dryer depicted in FIG. 1.

Referring to FIGS. 1 and 2, a washing machine combined with a dryer 100 includes an enclosing cabinet 110, a front cover 111 installed on a front of the cabinet 110, a door 120 openable mounted at a center of the front cover 111 for loading clothes, a tub 130 installed in the cabinet 110 to receive water, and a drum 135 installed in the tub 130 to receive clothes to be washed.

Also, the washing machine combined with the dryer 100 includes a motor 140, a control panel 112, a detergent dispenser 150, and a water inlet valve 180. The motor 140 is mounted on a back of the tub 130 with its shaft connected to the drum 135 to drive the drum 135, the control panel 112 is formed on an upper side of the front cover 111 with a plurality of buttons for a user to select operating conditions, the detergent dispenser 150 is installed beside the control panel 112 to receive washer detergents, fabric softeners, or the like, and the water inlet valve 180 is installed on an upper rear of inside of the cabinet 110 to control the inflow of water to the detergent dispenser 150.

Further, the washing machine combined with the dryer 100 includes a water inlet line 181 and a bellows 151. The water inlet line 181 connects the water inlet valve 180 and the detergent dispenser 150 for the water inflow, and the bellows 151 connects the detergent dispenser 150 and the tub 130 to allow the water to flow into the tub 130 after it is mixed with the wash detergents in the detergent dispenser 150.

Further, the washing machine combined with the dryer 100 includes a damper 131, a drain tube 171, a drain pump 170, and a drain hose 172. The damper 131 supports the tub 130 to dampen the vibration generated when the drum 135 is rotated, the drain tube 171 is connected to a bottom of the tub 130 to drain the water contaminated during a washing operation, the drain pump 170 is connected to an end of the drain tube 171 to pump out the contaminated water, and the drain hose 172 is connected from the drain pump 170 to the outside to discharge the pumped water to the outside.

Further, the washing machine combined with the dryer 100 includes a dryer duct 300, a heater 162, a dryer fan 160, a screening unit 400, a connecting tub 200, and an air-vent duct 190. The dryer duct 300 introduces surrounding air into the drum 135 to start a heat drying operation after the clothes are washed, rinsed, and spin dried. The heater 162 is installed in the dryer duct 300 to heat the introduced air to a high temperature, and the dryer fan 160 is installed in the dryer duct 300 to draw in the surrounding air. The screening unit 400 is pivotably installed in the dryer duct 300 to prevent a hot steam, generated in the drum 135 during a hot water washing operation, from reversely flowing through the dryer duct 300 to the outside. The air-vent duct 190 is installed in a rear side of the cabinet 110 and the connecting tub 200 is connected between the tub 130 and the air-vent duct 190, such that the air containing lots of moisture taken from the clothes during the heat drying operation can be discharged from the drum 135 to the outside.

An operation of the washing machine combined with the dryer 100 will now be described.

First, a user loads clothes in the drum 135 through the door 120 and fills the detergent dispenser 150 with detergent or fabric softener. Then, the user selects operating conditions using the control panel 112 and presses a start button to start a washing operation.

Upon the pressing of the start button a washing operation is started, and the water inlet valve 180 is opened to introduce water from a water source to the detergent dispenser 150. The introduced water is mixed with the detergent in the detergent dispenser 150 and the water containing detergent (washing water) is dropped down to the tub 130 through the bellows 151 until it fills the tub 130 to a predetermined level.

When the washing water is filed in the tub 130 to the predetermined level, the water inlet valve 180 is closed, and the motor 140 is operated to drive the connected drum 135. The clothes, as the drum 135 is rotated, is lifted up and dropped down in the drum 135 to force the washing water to pass through it to remove dirt.

After the washing operation, the washing water contaminated during the washing operation is drained from the tub 130 to the drain pump 170 through the drain tube 171. The drain pump 170 pumps out the contaminated water to the outside through the drain hose 172.

Meanwhile, if the washing operation is carried out using a hot water for washing certain kinds of clothes such as white cotton clothes, a hot steam is generated in the drum 135 during the hot water washing operation and it flows reversely to the dryer duct 300. The reversely flowing steam is blocked by the screening unit 400, such that it can be prevented from reversely flowing to the outside.

After the contaminated water is discharged, fresh water is introduced into the drum 135 through the water inlet line 181 for a rinsing operation. After the rinsing operation, a spin drying operation is carried out. In the spin drying operation, the drum 135 is rotated at a high speed to apply centrifugal force to the clothes to remove water from the clothes. After this spin drying operation, a heat drying operation is carried out.

In the heat drying operation, the heater 162 is powered on and heated to a high temperature, and the dryer fan 160 is rotated to draw in air into the dryer duct 300 from between the cabinet 110 and the tub 130. The drawn air is heated by the heater 162 to a high temperature and low humidity. The heated air is flows into the drum 135 along the dryer duct 300 to take moisture from the clothes in the drum 135. After taking moisture from the clothes, the air becomes humid and it is discharged from the drum 135 to the outside through the connecting tub 200 and the air-vent duct 190.

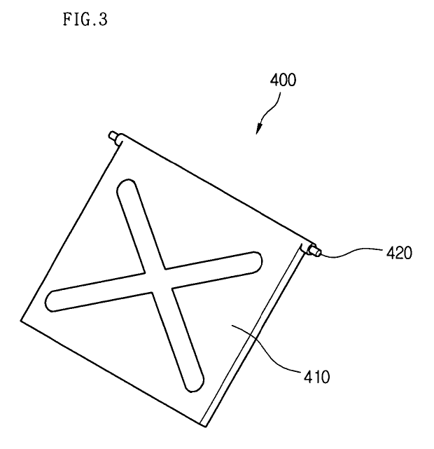

FIG. 3 is a perspective view of a screening unit according to an embodiment of the present invention.

Referring to FIG. 3, when assembled, the screening unit 400 is installed in the dryer duct 300 to prevent a hot steam from reversely flowing from the drum 135 to the outside through the dryer duct 300 during the hot water washing operation.

The screening unit 400 includes a screen 410 and a hinge 420. Substantially, the screen 410 is shaped after the inside shape of the dryer duct 300. The hinge 420 is protruded at each upper side of the screen 410, such that the screening unit 400 can be pivotably installed.

That is, the hinge 420 is formed along an end of the screen 410 to protrude outwardly, such that when the screening unit 400 is installed in the 300 the screen 410 can be tilted about the hinge 420 by the pressure of air flowing through the dryer duct 300. When assembled, the hinge 420 is rotatably fitted into each inner side of the 300, such that the screening unit 400 can be rotated a predetermined angle from a closed position to allow airflow from the dryer fan 160 to the tub 130 When the heat drying operation is carried out. On the other hand, the screening unit 400 can be maintained in a vertical, closed position when the heat drying operation is not carried out.

A configuration and operation of the dryer fan 300, in which the screening unit is installed, will now be more fully described with reference to the accompanying drawings.

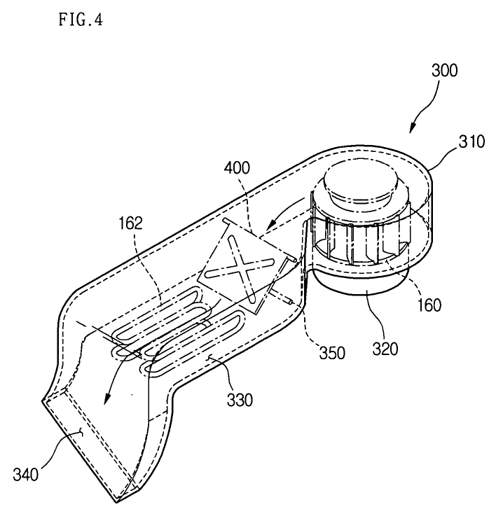

FIG. 4 shows an inside of a dryer duct during a heat drying operation according to an embodiment of the present invention.

Referring to FIG. 4, the screening unit 400 in the dryer duct 300 is tilted at a certain angle during a heat drying operation.

The dryer duct 300, in which the screening unit 400 is installed, includes a fan receiving portion 310, an air passage 330, an air outlet 340, and an air inlet 320. The fan receiving portion 310 has a smooth curvature and receives the dryer fan 160, the air passage 330 is extended from the dryer fan 160 to provide an air passage, the air outlet 340 is defined at an end of the air passage 330 to direct air drawn in by the dryer fan 160 toward the tub 130, and the air inlet 320 is extended downwardly from a bottom of the fan receiving portion 310 and formed with a hole to pass air therethrough.

In detail, the heater 162 is mounted in the air passage 330 to heat the air drawn in by the dryer fan 160 before the air flows into the tub 130, and the air passage 330 is bent downwardly at its end for connection with the tub 130. The fan receiving portion 310 has a smooth curvature to minimize airflow resistance. That is, when the dryer fan 160 draws in air in an axial direction and blows the air in a radial direction, the air is smoothly guided by the smooth curvature of the wall of the dryer duct 300, thereby reducing the airflow resistance.

Meanwhile, in the dryer duct 300, the screening unit 400 is installed to allow airflow from the dryer fan 160 to the tub 130 during the heat drying operation and to prevent a hot steam from reversely flowing from the tub 130 to the dryer fan 160 during the hot water washing operation.

If the screening unit 400 is installed in front of the heater 162, hot air from the heater 162 may deform the screening unit 400 or burn the screening unit 400. Therefore, the screening unit 400 may be installed in the dryer duct 300 between the dryer fan 160 and the heater 162. However, the installing location is not limited to the position between the dryer fan 160 and the heater 162. The screening unit 400 may be installed between the heater 162 and the air outlet 340 if it is made of heat resistant material.

Also, for an easy rotation by the air blown from the dryer fan 160 and a high durability against the hot steam from the tub 130, the screening unit 400 may be made of light and rustproof material, such as stainless steel.

Further, a rotation control unit such as a stopper 350 may be protruded from an inner bottom of the dryer duct 300 to prevent the screening unit 400 from rotating toward the dryer fan 160 from a vertically closed position.

The stopper 350 may include one or more protrusions or may be formed in a continuous rib shape. By the stopper 350, the screening unit 400 is prevented from rotating toward the dryer fan 160 by the reversely flowing hot steam during the washing operation, such that the hot steam can be prevented from reversely flowing into the dryer fan 160 and reversely passing through the air inlet 320.

Alternatively, the screening unit 400 may have the same width as the inner width of the dryer duct 300 but have a longer height than the inner height of the dryer duct 300, such that the screening unit 400 is inclined at a predetermined angle when it closed the dryer duct 300. Therefore, the screening unit 400 can be prevented from rotating toward the dryer fan 160 from a closed position without the stopper 350.

In a heat drying operation, the dryer fan 160 is rotated to draw in air from between the cabinet 110 and the tub 130. The drawn air flows along the inner wall of the fan receiving portion 310 and reaches the screening unit 400, and the screening unit 400 is rotated a predetermined angle by the pressure of the air to allow the air to flow toward the air outlet 340 along the air passage 330. The air, as it passes through the air passage 330, is heated to a high temperature by the heater 162. The heated air further flows into the tub 130 through the air outlet 340. Then, the heated air enters the drum 135 from the tub 130 through a plurality of holes defined in the drum 135. In the drum 135, the heated, low-humidity air takes moisture from the clothes to dry the clothes.

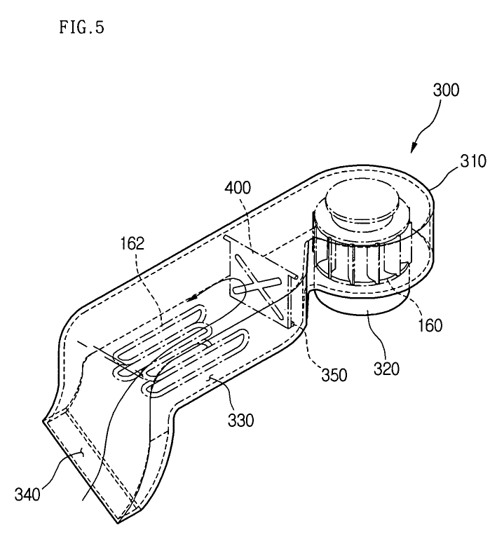

FIG. 5 shows an inside of a dryer duct when a heat drying operation is not carried out according to an embodiment of the present invention.

Referring to FIG. 5, when the heat drying operation is not carried out, the screening unit 400 is kept in a closed position to close the dryer duct 300.

When the hot steam, generated from the drum 135 in the washing or rinsing operation, reversely flows to the dryer duct 300, the screening unit 400 blocks the hot steam. Therefore, the hot steam can be prevented from flowing into the inner space between the cabinet 110 and the tub 130 through the air inlet 320.

That is, the screening unit 400 is kept in a vertically closed position as shown in FIG. 5. The stopper 350 securely supports the screening unit 400 against the pushing force of the hot steam, such that the screening unit 400 can be stably kept in the closed position without rotation to the dryer fan 160.

Meanwhile, by making the height of the screening unit 400 longer than the inner height of the dryer duct 300 as described above, the screening unit 400 can be stably kept in the closed position at an inclined angle without the support of the stopper 350.

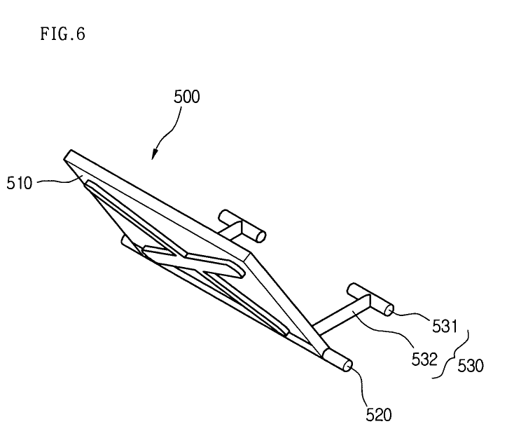

FIG. 6 is a perspective view of a screening unit according to another embodiment of the present invention.

Referring to FIG. 6, a screening unit 500 is provided to prevent the reverse flow of the hot steam. The screening unit 500 includes a screen 510, a rotation control unit such as stoppers 530 formed at a lower end of the screen 510, and a hinge 520 protruded from each side of the screen 510.

Each of the stopper 530 is extended from the lower end of the screen 510, and it includes a support rod 532 extended from the screen 510 at a predetermined angle and a weight 531 formed at a free end of the support rod 532.

When a heat drying operation is carried out, the screen 510 comes into contact with the inner bottom of the dryer duct 300 to open the dryer duct 300. On the other hands, when the heat drying operation is not carried out, the screen 510 is rotated up from the inner bottom of the dryer duct 300 to close the dryer duct 300. In this closed position, the support rod 532 prevents over rotation of the screen 510 toward the dryer fan 160. That is, the screen 510 is kept in a stand-up position (closed position) when the heat drying operation is not carried out.

If the support rod 532 is extended from the screen 510 at a right angle, the screen 510 may have the same width and height as the inner width and height of the dryer duct 300. Further, if the support rod 532 is extended from the screen 510 at an angle larger than 90 degrees, the screen 510 makes an angle with the vertical when it is rotated up from the closed position. Therefore, the screen 510 may have the same width as the inner width of the dryer duct 300 but a height lager than the inner height of the dryer duct 300 in order to securely close the dryer duct 300 when it is rotated up from the closed position.

The length of the support rod 532 and the size of the weight 531 are properly selected such that the screen 510 can make contact with the inner bottom of the dryer duct 300 during the heat drying operation and it can be rotated up by the torque generated by the weight 531 and the support rod 532 after the heat drying operation.

In detail, during washing and rinsing operations, the weight 531 and the support rod 532 make contact with the inner bottom of the dryer duct 300, and the screen 510 closes the dryer duct 300. In the heat drying operation after the rinsing operation, the screen 510 is rotated down and makes contact with the inner bottom of the dryer duct 300 by the pressure of the air drawn in by the dryer fan 160, such that the dryer duct 300 can be opened during the heat drying operation. After the heat drying operation, the screen 510 is rotated up to close the dryer duct 300 again. That is, the torque generated by the weight 531 is larger than the torque generated by weight of the screen 510, such that the screen 510 can be rotated upwardly about the hinge 520 to close the dryer duct 300 when the heat drying operation is not carried out.

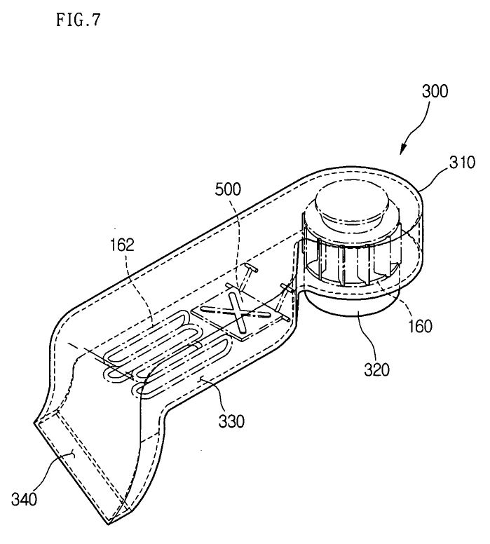

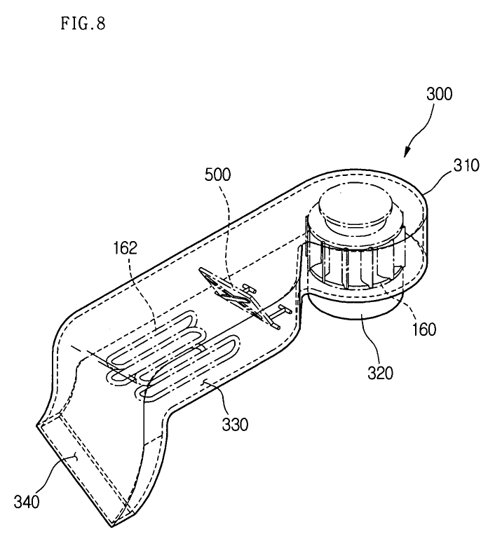

FIG. 7 shows an inside of a dryer duct during a heat drying operation according to another embodiment of the present invention, and FIG. 8 shows an inside of a dryer duct when a heat drying operation is not carried out according to another embodiment of the present invention.

The screening unit 500 is in an open position to open the dryer duct 300 during the heat drying operation as shown in FIG. 7, and the screening unit 500 is in a close position to close the dryer duct 300 when the heat drying operation is not carried out as shown in FIG. 8.

In detail, the screening unit 500 is installed in the dryer duct 300 and it is rotatable in the dryer duct 300 about the hinge 520. That is, the hinge 520, protruded from each lower side of the screening unit 500, is rotatably fitted into the inner wall of the dryer duct 300. When the dryer fan 160 draws in air from the outside for the heat drying operation, the screen 510 comes into contact with the inner bottom of the dryer duct 300 by the pressure of the drawn air, such that the air can flow to the air passage 330 where it is heated by the heater 162. After heated, the air further flows toward the tub 130 through the air outlet 340.

Meanwhile, during the washing and rinsing operations, the screen 510 is rotated up by the stopper 530, and the stopper 530 comes into contact with the inner bottom of the dryer duct 300. Here, the screen 510 may make an angle with the vertical according to the angle between the screen 510 and the support rod 532 of the stopper 530. That is, if the support rod 532 and the screen 510 make an angle larger than 90 degrees, the screen 510 closes the dryer duct 300 at an inclined angle to the vertical.

Further, an elastic member such as a spring can be used to maintain the screen 510 in the rotated-position (close position) when the heat drying operation is not carried out.

The spring may have one end abutted on the screen 510 and the other end abutted on the inner bottom of the dryer duct 300. When the heat drying operation is carried out, the air blown from the dryer fan 160 rotates down the 510 while compressing the spring, and after the heat drying operation the spring rotates up the screen 510 and maintains the screen 510 in the rotated-up position.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A washing machine combined with a dryer, comprising:
a tub;
a dryer duct installed outside of the tub, the dryer duct including an air inlet to introduce a surrounding air, an air outlet connected to the tub to allow the introduced air to flow into the tub, and an air passage formed between the air inlet and the air outlet to pass the introduced air therethrough;
a dryer fan installed in the dryer duct to draw in the surrounding air;
a heater installed in the dryer duct to apply heat to the drawn-in air; and
a screening unit installed in the dryer duct to selectively block the flow of the air.

2. The washing machine according to claim 1, wherein the screening unit is rotatably installed in the dryer duct.

3. The washing machine according to claim 1, wherein the screening unit is made of stainless steel.

4. The washing machine according to claim 1, wherein the screening unit includes:
a screen having a predetermined size; and
a hinge protruded from a side of the screen to allow rotation of the screen.

5. The washing machine according to claim 4, wherein the predetermined size of the screen is equal to or larger than the interior size of the cross section of the dryer fan.

6. The washing machine according to claim 1, wherein the dryer duct further includes a stopper protruded from an inner surface thereof to prevent over-rotation of the screening unit.

7. The washing machine according to claim 6, wherein the stopper is a protrusion or a rib.

8. The washing machine according to claim 1, wherein the screening unit includes:
a screen;
a hinge protruded from a side of the screen; and
a stopper formed at an end of the screen.

9. The washing machine according to claim 8, wherein the screen and the stopper make an angle of 90 degrees or more with each other.

10. The washing machine according to claim 8, wherein the stopper includes:
a support rod extended from the end of screen with a predetermine length; and
a weight formed at a free end of the support rod with a predetermined size.

11. The washing machine according to claim 1, wherein the screening unit opens the dryer duct when a heat drying operation is carried out and closes the dryer duct when the heat drying operation is not carried out.

12. The washing machine according to claim 1, further comprising an elastic member to facilitate the selective blocking action of the screening unit, the elastic member having one end connected to the screening unit and the other end connected to an inner surface of the dryer duct.

13. The washing machine according to claim 1, wherein the screening unit is installed between the dryer fan and the heater.

14. A washing machine combined with a dryer, comprising:
a cabinet;
a tub accommodated in the cabinet;
a dryer duct allowing a surrounding air to flow inside of the tub from between the cabinet and the tub;
a dryer fan installed in the dryer duct to draw in the surrounding air;
a heater installed in the dryer duct to apply heat to the drawn-in air; and
a screening unit including a screen rotatably installed in the dryer duct and a hinge protruded from a side of the screen.

15. The washing machine according to claim 14, wherein the screening unit is made of heat and/or rust resistant material.

16. The washing machine according to claim 14, wherein the screen has a height larger than the interior height of the dryer duct to prevent over-rotation of the screen toward the dryer fan when a heat drying operation is not carried out.

17. The washing machine according to claim 14, wherein when a heat drying operation is not carried out, the screening unit securely closes the dryer duct to prevent a hot steam of the tub from reversely passing through the dryer duct.

18. The washing machine according to claim 14, wherein when a heat drying operation is carried out the screen is rotated by the air draw in by the dryer fan.

19. The washing machine according to claim 14, further comprising a rotation control unit to keep the screen in a substantially vertical position when a heat drying operation is not carried out.

20. The washing machine according to claim 19, wherein the rotation control unit includes a stopper protruded from an inner surface of the dryer duct to prevent over-rotation of the screen.

21. The washing machine according to claim 19, wherein the rotation control unit is formed at an end of the screen and includes a weight to apply torque to the screen.

22. The washing machine according to claim 19, wherein the rotation control unit is a spring having one end connected to the screen and the other end connected to an inner surface of the dryer duct.

23. A washing machine combined with a dryer, comprising:
a dryer duct;
a dryer fan installed in the dryer duct to draw in a surrounding air;
a heater installed in the dryer duct to apply heat to the drawn-in air; and
a screening unit including a screen rotatably installed in the dryer duct and a hinge protruded from a side of the screen.
